(19) United States
(12) Patent Application Publication
(10) Pub. No.: US 2026/0236819 A1
(43) Pub. Date: Aug. 13, 2026

(54) ROUTING QUANTUM CIRCUITS USING MACHINE LEARNING

(71) Applicant: International Business Machines Corporation, Armonk, NY (US)

(72) Inventors: Daniel Josef Egger, Zurich (CH); Elena Peña Tapia, Zurich (CH); Stefan Woerner, Zurich (CH); David Kremer Garcia, White Plains, NY (US); Juan Cruz Benito, Salamanca (ES)

(21) Appl. No.: 19/068,882

(22) Filed: Mar. 3, 2025

(30) Foreign Application Priority Data
Dec. 9, 2024 (EP) 24383344.9

(51) Int. Cl. G06N 10/60

(52) U.S. Cl. CPC G06N 10/60

(57) ABSTRACT

A method, computer program product, and system for routing quantum circuits. A structure of a quantum circuit to route is encoded in an environment using a reinforcement learning agent. A noise of a built routed quantum circuit is encoded in a cost function, such as by measuring the noise in the layer(s) of gates of the built routed quantum circuit. The structure of a quantum circuit refers to the sequence of quantum gates applied to qubits. A cost function refers to a mathematical function that measures how well the predictions of the machine learning model align with the actual target values. Quantum circuit routing is then performed using a trained machine learning model based on the structure of the quantum circuit and minimizing the cost function, which reduces the gate count and noise since the structure facilitates the routing task and noise minimization as encoded in the cost function.

### TECHNICAL FIELD

The present disclosure relates generally to quantum circuit routing, and more particularly to performing quantum circuit routing using machine learning based on encoding the structure of the quantum circuit to route and the noise of a built routed quantum circuit in a cost function.

### BACKGROUND

Quantum circuit routing is the process of modifying a quantum circuit so that it meets the connectivity requirements of a target quantum processor. Such a process involves mapping virtual qubits to physical qubits, commonly referred to as a layout. Furthermore, such a process involves inserting SWAP gates (gate that swaps the states of two qubits), which are used to reposition logical qubits so that they are adjacent to each other. This allows the logical gates to only occur between adjacent physical qubits. Additionally, such a process involves minimizing circuit depth (count of the time steps needed to execute all the gates in the quantum circuit). The goal is to minimize the amount of circuit depth added by the SWAP gates.

When routing quantum circuits, there are various factors that need to be taken into consideration. For example, not all qubits are connected. Some qubits can be far apart on the chip. Furthermore, SWAP gates are costly and prone to errors. As a result, it is best to avoid using too many SWAP gates. Furthermore, quantum systems are prone to errors and noise, which can affect the accuracy and reliability of quantum circuit routing. For example, quantum hardware is noisy emanating from noise sources, such as energy loss during idle times, loss of coherence in quantum states, static crosstalk (e.g., type of unwanted coupling between qubits that occurs due to always-on qubit-qubit coupling), dynamic crosstalk (e.g., gate induced crosstalk where a gate disturbs neighboring gates or qubits), etc.

Algorithms, such as quantum routing algorithms, may be utilized to route quantum circuits. Several quantum routing algorithms include noise in either heuristic algorithms or formal models. Unfortunately, such heuristic algorithms are typically sub-optimal (difficulty in identifying circuits with low gate counts) and perform poorly involving quantum circuits with given symmetries or structures. Furthermore, such formal models do not scale beyond a handful of qubits.

In the process of routing quantum circuits, it is desirable to modify the quantum circuit to have a low gate count which minimizes the impact of noise. By minimizing the impact of noise, it makes it easier to perform error mitigation as well as obtain better results in cases where error mitigation is not possible (e.g., sampling-based problems, such as combinational optimization).

Unfortunately, current quantum routing algorithms are deficient in routing quantum circuits by modifying the quantum circuit to have a low gate count which minimizes the impact of noise.

### SUMMARY

In one embodiment of the present disclosure, a method for routing quantum circuits comprises encoding a structure of a quantum circuit to route and noise of a built routed quantum circuit in a cost function. The method further comprises performing quantum circuit routing using a trained machine learning model based on minimizing the cost function.

Furthermore, in one embodiment of the present disclosure, the method additionally comprises encoding the structure of the quantum circuit to route in an environment using a reinforcement learning agent.

Additionally, in one embodiment of the present disclosure, a cost operator built from a set of commuting gates is represented in the environment as a flat set of edges on which gates act.

Furthermore, in one embodiment of the present disclosure, the environment encodes Pauli strings, where the reinforcement learning agent identifies an order of the Pauli strings which produces a maximum number of controlled-X (CX) ladder cancellations.

Additionally, in one embodiment of the present disclosure, the noise of the built routed quantum circuit is encoded in the cost function by measuring noise in one or more layers of gates of the built routed quantum circuit.

Furthermore, in one embodiment of the present disclosure, the method additionally comprises selecting one of a plurality of machine learning models to perform the quantum circuit routing based on the structure of the quantum circuit to route.

Additionally, in one embodiment of the present disclosure, the machine learning model is trained using a reinforcement learning approach comprising updating, by an agent, a network of SWAP gates applied to the quantum circuit to route. The reinforcement learning approach further comprises applying, by the agent, triggered hooks in an environment. The reinforcement learning approach additionally comprises replacing a directed acyclic graph of the quantum circuit to route with a data structure representing the quantum circuit to route. Furthermore, the reinforcement learning approach comprises building a routed quantum circuit to apply SWAP gates and elements from the data structure. Additionally, the reinforcement learning approach comprises computing the cost function and a reward to evaluate a strength of noise in the built routed quantum circuit.

Furthermore, in one embodiment of the present disclosure, the trained machine learning model pre-processes the structure of the quantum circuit to route to reduce a number of SWAP gates.

Additionally, in one embodiment of the present disclosure, the cost function is based on a number of layers of two-qubit gates, where the noise of the built routed quantum circuit is encoded in the cost function based on a noise cost of the layers of the two-qubit gates.

Other forms of the embodiments of the method described above are in a system and in a computer program product.

Accordingly, embodiments of the present disclosure perform quantum circuit routing in a manner that modifies the quantum circuit to have a low gate count which minimizes the impact of noise thereby enabling error mitigation to be performed or to obtain better results in cases where error mitigation is not possible.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the classical computer for performing quantum circuit routing using machine learning in a manner that modifies the quantum circuit to have a low gate count which minimizes the impact of noise thereby enabling error mitigation to be performed or to obtain better results in cases where error mitigation is not possible in accordance with an embodiment of the present disclosure;

FIG. 3 is a diagram of training the machine learning model to reduce the number of SWAP gates in the structure of the quantum circuit based on a reinforcement learning approach involving a single-round game in accordance with an embodiment of the present disclosure;

FIG. 4 illustrates encoding the structure of a quantum circuit for the quantum approximate optimization algorithm in a reinforcement learning environment in accordance with an embodiment of the present disclosure;

FIG. 5 illustrates encoding the structure of a quantum circuit for Trotter simulations in a reinforcement learning environment in accordance with an embodiment of the present disclosure;

FIG. 6 illustrates encoding the noise of the quantum circuit in a cost function in accordance with an embodiment of the present disclosure;

FIG. 7 illustrates routing the quantum circuit using a selected trained machine learning model in accordance with an embodiment of the present disclosure;

FIG. 8 illustrates an embodiment of the present disclosure of the hardware configuration of the classical computer which is representative of a hardware environment for practicing the present disclosure;

FIG. 9 is a flowchart of a method for performing quantum circuit routing using machine learning in a manner that modifies the quantum circuit to have a low gate count which minimizes the impact of noise in accordance with an embodiment of the present disclosure;

FIG. 10 is a flowchart of a method for training the machine learning model to reduce the number of SWAP gates in the structure of the quantum circuit to route based on a reinforcement learning approach involving a single-round game in accordance with an embodiment of the present disclosure; and

FIG. 11 is a flowchart of a method for encoding the structure of the quantum circuit to route and the noise of the built routed quantum circuit in a cost function in accordance with an embodiment of the present disclosure.

### DETAILED DESCRIPTION

In one embodiment of the present disclosure, a method for routing quantum circuits comprises encoding a structure of a quantum circuit to route and noise of a built routed quantum circuit in a cost function. The method further comprises performing quantum circuit routing using a trained machine learning model based on minimizing the cost function.

In this manner, quantum circuit routing is performed in a manner that modifies the quantum circuit to have a low gate count which minimizes the impact of noise thereby enabling error mitigation to be performed or to obtain better results in cases where error mitigation is not possible.

Furthermore, in one embodiment of the present disclosure, the method additionally comprises encoding the structure of the quantum circuit to route in an environment using a reinforcement learning agent.

In this manner, the structure of the quantum circuit to route is encoded in the cost function.

Additionally, in one embodiment of the present disclosure, a cost operator built from a set of commuting gates is represented in the environment as a flat set of edges on which gates act.

In this manner, the structure of the quantum circuit corresponding to a specific type of quantum circuit for the quantum approximate optimization algorithm is encoded in the cost function.

Furthermore, in one embodiment of the present disclosure, the environment encodes Pauli strings, where the reinforcement learning agent identifies an order of the Pauli strings which produces a maximum number of controlled-X (CX) ladder cancellations.

In this manner, the structure of the quantum circuit corresponding to a specific type of quantum circuit algorithm involving Trotter simulations is encoded in the cost function.

Additionally, in one embodiment of the present disclosure, the noise of the built routed quantum circuit is encoded in the cost function by measuring noise in one or more layers of gates of the built routed quantum circuit.

In this manner, the noise of the built routed quantum circuit is encoded in the cost function.

Furthermore, in one embodiment of the present disclosure, the method additionally comprises selecting one of a plurality of machine learning models to perform the quantum circuit routing based on the structure of the quantum circuit.

In this manner, a service, such as the transpilation service, selects a previously trained machine learning model that is most appropriate for performing quantum circuit routing.

Additionally, in one embodiment of the present disclosure, the machine learning model is trained using a reinforcement learning approach comprising updating, by an agent, a network of SWAP gates applied to the quantum circuit to route. The reinforcement learning approach further comprises applying, by the agent, triggered hooks in an environment. The reinforcement learning approach additionally comprises replacing a directed acyclic graph of the quantum circuit to route with a data structure representing the quantum circuit to route. Furthermore, the reinforcement learning approach comprises building a routed quantum circuit to apply SWAP gates and elements from the data structure. Additionally, the reinforcement learning approach comprises computing the cost function and a reward to evaluate a strength of noise in the built routed quantum circuit.

In this manner, the machine learning model is trained using a reinforcement learning approach involving a single-round game.

Furthermore, in one embodiment of the present disclosure, the trained machine learning model pre-processes the structure of the quantum circuit to route to reduce a number of SWAP gates.

In this manner, the trained machine learning model reduces the number of SWAP gates in connection with performing quantum circuit routing.

Additionally, in one embodiment of the present disclosure, the cost function is based on a number of layers of two-qubit gates, where the noise of the built routed quantum circuit is encoded in the cost function based on a noise cost of the layers of the two-qubit gates.

In this manner, the noise of the built routed quantum circuit is encoded in the cost function.

Other forms of the embodiments of the method described above are in a system and in a computer program product.

As stated above, quantum circuit routing is the process of modifying a quantum circuit so that it meets the connectivity requirements of a target quantum processor. Such a process involves mapping virtual qubits to physical qubits, commonly referred to as a layout. Furthermore, such a process involves inserting SWAP gates (gate that swaps the states of two qubits), which are used to reposition logical qubits so that they are adjacent to each other. This allows the logical gates to only occur between adjacent physical qubits. Additionally, such a process involves minimizing circuit depth (count of the time steps needed to execute all the gates in the quantum circuit). The goal is to minimize the amount of circuit depth added by the SWAP gates.

When routing quantum circuits, there are various factors that need to be taken into consideration. For example, not all qubits are connected. Some qubits can be far apart on the chip. Furthermore, SWAP gates are costly and prone to errors. As a result, it is best to avoid using too many SWAP gates. Furthermore, quantum systems are prone to errors and noise, which can affect the accuracy and reliability of quantum circuit routing. For example, quantum hardware is noisy emanating from noise sources, such as energy loss during idle times, loss of coherence in quantum states, static crosstalk (e.g., type of unwanted coupling between qubits that occurs due to always-on qubit-qubit coupling), dynamic crosstalk (e.g., gate induced crosstalk where a gate disturbs neighboring gates or qubits), etc.

Algorithms, such as quantum routing algorithms, may be utilized to route quantum circuits. Several quantum routing algorithms include noise in either heuristic algorithms or formal models. Unfortunately, such heuristic algorithms are typically sub-optimal (difficulty in identifying circuits with low gate counts) and perform poorly involving quantum circuits with given symmetries or structures. Furthermore, such formal models do not scale beyond a handful of qubits.

In the process of routing quantum circuits, it is desirable to modify the quantum circuit to have a low gate count which minimizes the impact of noise. By minimizing the impact of noise, it makes it easier to perform error mitigation as well as obtain better results in cases where error mitigation is not possible (e.g., sampling-based problems, such as combinational optimization).

Unfortunately, current quantum routing algorithms are deficient in routing quantum circuits by modifying the quantum circuit to have a low gate count which minimizes the impact of noise.

The embodiments of the present disclosure provide the means for routing quantum circuits by modifying the quantum circuit to have a low gate count which minimizes the impact of noise. In one embodiment, such routing of the quantum circuit is performed using a machine learning-based method by encoding the structure of the quantum circuit to route and the noise of a built routed quantum circuit in a machine learning cost function. In one embodiment, a machine learning model (e.g., neural network) is trained to route quantum circuits based on pre-processing the structure of the quantum circuit to route to reduce the number of SWAP gates and minimizing the cost function using reinforcement learning. In one embodiment, the structure of the quantum circuit to route, where such a structure may be a specific type of quantum circuit for a particular type of quantum algorithm (e.g., quantum approximate optimization algorithm, Trotter simulations, generation of bell pairs serving as a building block for quantum computing applications, etc.), is encoded in an environment to which a reinforcement learning agent is exposed. Furthermore, the noise of a built routed quantum circuit is encoded in a cost function, which is used during training of the machine learning model by reinforcement learning using a reinforcement learning agent. In one embodiment, multiple machine learning models are trained in the manner discussed above for routing quantum circuits with different structures. As a result, upon receiving the structure of a particular quantum circuit to be routed, one of these trained machine learning models is selected to route the quantum circuit based on the structure of the quantum circuit that most closely matches the structure of the quantum circuits for which such a machine learning model is trained to perform quantum circuit routing. In this manner, quantum circuit routing is performed in a manner that modifies the quantum circuit to have a low gate count which minimizes the impact of noise thereby enabling error mitigation to be performed or to obtain better results in cases where error mitigation is not possible. These and other features will be discussed in further detail below.

In some embodiments of the present disclosure, the present disclosure comprises a method, computer program product, and system for routing quantum circuits. In one embodiment of the present disclosure, a structure of a quantum circuit to route and the noise of a built routed quantum circuit are encoded in a cost function. The structure of a quantum circuit, as used herein, refers to the sequence of quantum gates applied to qubits. Noise, as used herein, refers to the unwanted perturbations or errors that occur during the execution of gates (e.g., two-qubit gates) causing the quantum state of the qubits to deviate from the intended ideal state due to interaction with the environment or imperfections in the physical hardware potentially leading to incorrect computation results. A cost function, as used herein, refers to a mathematical function that measures how well the predictions of the machine learning model (e.g., neural network) align with the actual target values. That is, it quantifies the error between the predicted outputs and the true outputs. In one embodiment, the structure of the quantum circuit to route is encoded in the cost function using a reinforcement learning approach, such as a single-round game. That is, the structure of the quantum circuit to route is encoded within a reinforcement learning environment in which the reinforcement learning agent is exposed. Furthermore, noise is encoded in the cost function, such as by measuring the noise in one or more layers of gates of a built routed quantum circuit. Quantum circuit routing is then performed using a trained machine learning model based on minimizing the cost function, which reduces the gate count and noise since the structure and noise are encoded in the cost function. In this manner, the routing of the quantum circuit is performed in a manner that modifies the quantum circuit to have a low gate count which minimizes the impact of noise thereby enabling error mitigation to be performed or to obtain better results in cases where error mitigation is not possible.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

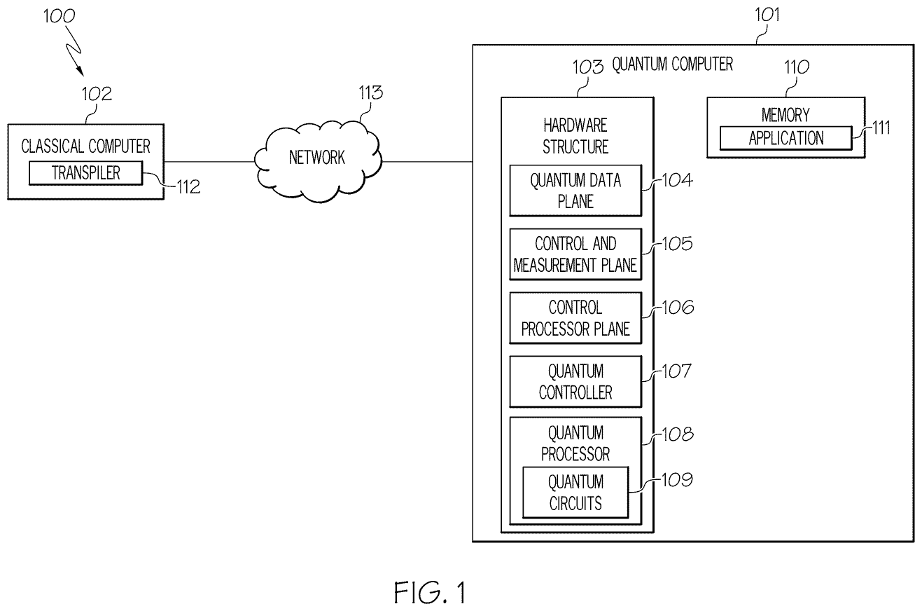

Referring now to the Figures in detail, FIG. 1 illustrates an embodiment of the present disclosure of a communication system 100 for practicing the principles of the present disclosure. Communication system 100 includes a quantum computer 101 configured to perform quantum computations, such as the types of computations that harness the collective properties of quantum states, such as superposition, interference, and entanglement, as well as a classical computer 102 in which information is stored in bits that are represented logically by either a 0 (off) or a 1 (on). Examples of classical computer 102 include, but are not limited to, a portable computing unit, a Personal Digital Assistant (PDA), a laptop computer, a mobile device, a tablet personal computer, a smartphone, a mobile phone, a navigation device, a gaming unit, a desktop computer system, a workstation, and the like configured with the capability of connecting to network 113 (discussed below).

In one embodiment, classical computer 102 is used to set up the state of quantum bits in quantum computer 101 and then quantum computer 101 starts the quantum process. Furthermore, in one embodiment, classical computer 102 is configured to perform quantum circuit routing using machine learning in a manner that modifies the quantum circuit to have a low gate count which minimizes the impact of noise thereby enabling error mitigation to be performed or to obtain better results in cases where error mitigation is not possible.

In one embodiment, a hardware structure 103 of quantum computer 101 includes a quantum data plane 104, a control and measurement plane 105, a control processor plane 106, a quantum controller 107, and a quantum processor 108. While depicted as being located on a single machine, quantum data plane 104, control and measurement plane 105, and control processor plane 106 may be distributed across multiple computing machines, such as in a cloud computing architecture, and communicate with quantum controller 107, which may be located in close proximity to quantum processor 108.

Quantum data plane 104 includes the physical qubits or quantum bits (basic unit of quantum information in which a qubit is a two-state (or two-level) quantum-mechanical system) and the structures needed to hold them in place. In one embodiment, quantum data plane 104 contains any support circuitry needed to measure the qubits' state and perform gate operations on the physical qubits for a gate-based system or control the Hamiltonian for an analog computer. In one embodiment, control signals routed to the selected qubit(s) set a state of the Hamiltonian. For gate-based systems, since some qubit operations require two qubits, quantum data plane 104 provides a programmable “wiring” network that enables two or more qubits to interact.

Control and measurement plane 105 converts the digital signals of quantum controller 107, which indicates what quantum operations are to be performed, to the analog control signals needed to perform the operations on the qubits in quantum data plane 104. In one embodiment, control and measurement plane 105 converts the analog output of the measurements of qubits in quantum data plane 104 to classical binary data that quantum controller 107 can handle.

Control processor plane 106 identifies and triggers the sequence of quantum gate operations and measurements (which are subsequently carried out by control and measurement plane 105 on quantum data plane 104). These sequences execute the program, provided by quantum processor 108, for implementing a quantum algorithm.

In one embodiment, control processor plane 106 runs the quantum error correction algorithm (if quantum computer 101 is error corrected).

In one embodiment, quantum processor 108 uses qubits to perform computational tasks. In the particular realms where quantum mechanics operate, particles of matter can exist in multiple states, such as an “on” state, an “off” state, and both “on” and “off” states simultaneously. Quantum processor 108 harnesses these quantum states of matter to output signals that are usable in data computing.

In one embodiment, quantum processor 108 performs algorithms which conventional processors are incapable of performing efficiently.

In one embodiment, quantum processor 108 includes one or more quantum circuits 109. Quantum circuits 109 may collectively or individually be referred to as quantum circuits 109 or quantum circuit 109, respectively. A “quantum circuit 109,” as used herein, refers to a model for quantum computation in which a computation is a sequence of quantum logic gates, measurements, initializations of qubits to known values and possibly other actions. A “quantum logic gate,” as used herein, is a reversible unitary transformation on at least one qubit. Quantum logic gates, in contrast to classical logic gates, are all reversible. Examples of quantum logic gates include RX (also identified as Rx) (performs e^{-iθX/2}, which corresponds to a rotation of the qubit state around the X-axis by the given angle theta θ on the Bloch sphere), RY (also identified as Ry) (performs e^{iθY/2}, which corresponds to a rotation of the qubit state around the Y-axis by the given angle theta θ on the Bloch sphere), RXX (performs the operation e^{(-iθX⊗X/2)} on the input qubit), RZZ (takes in one input, an angle theta θ expressed in radians, and it acts on two qubits), etc. In one embodiment, quantum circuits 109 are written such that the horizontal axis is time, starting at the left-hand side and ending at the right-hand side.

Furthermore, in one embodiment, quantum circuit 109 corresponds to a command structure provided to control processor plane 106 on how to operate control and measurement plane 105 to run the algorithm on quantum data plane 104/quantum processor 108.

Furthermore, quantum computer 101 includes memory 110, which may correspond to quantum memory. In one embodiment, memory 110 is a set of quantum bits that store quantum states for later retrieval. The state stored in quantum memory 110 can retain quantum superposition.

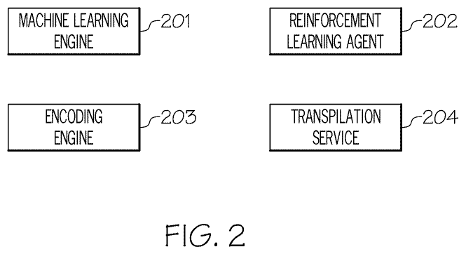

In one embodiment, memory 110 stores an application 111 that may be configured to implement one or more of the methods described herein in accordance with one or more embodiments. For example, application 111 may implement a program for performing quantum circuit routing using machine learning in a manner that modifies the quantum circuit to have a low gate count which minimizes the impact of noise thereby enabling error mitigation to be performed or to obtain better results in cases where error mitigation is not possible as discussed further below in connection with FIGS. 2-7 and 9-11. Examples of memory 110 include light quantum memory, solid quantum memory, gradient echo memory, electromagnetically induced transparency, etc.

Furthermore, in one embodiment, classical computer 102 includes a “transpiler 112,” which as used herein, is configured to rewrite an abstract quantum circuit 109 into a functionally equivalent one that matches the constraints and characteristics of a specific target quantum device. In one embodiment, transpiler 112 (e.g., qiskit.transpiler, where Qiskit® is an open-source software development kit) rewrites a given input circuit to match the topology of a specific quantum device and/or to optimize the quantum circuit for execution. In one embodiment, transpiler 112 converts a trained machine learning model upon execution on quantum hardware 103 to its elementary instructions and maps it to physical qubits.

In one embodiment, quantum machine learning models are based on variational quantum circuits 109. Such models consist of data encoding, processing parameterized with trainable parameters, and measurement/post-processing.

In one embodiment, the number of qubits (basic unit of quantum information in which a qubit is a two-state (or two-level) quantum-mechanical system) is determined by the number of features in the data. This processing stage may include multiple layers of parameterized gates. As a result, in one embodiment, the number of trainable parameters is (number of features)*(number of layers).

Furthermore, as shown in FIG. 1, classical computer 102, which is used to set up the state of quantum bits in quantum computer 101, may be connected to quantum computer 101 via network 113.

Network 113 may be, for example, a quantum network, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, a cellular network and various combinations thereof, etc. Other networks, whose descriptions are omitted here for brevity, may also be used in conjunction with system 100 of FIG. 1 without departing from the scope of the present disclosure.

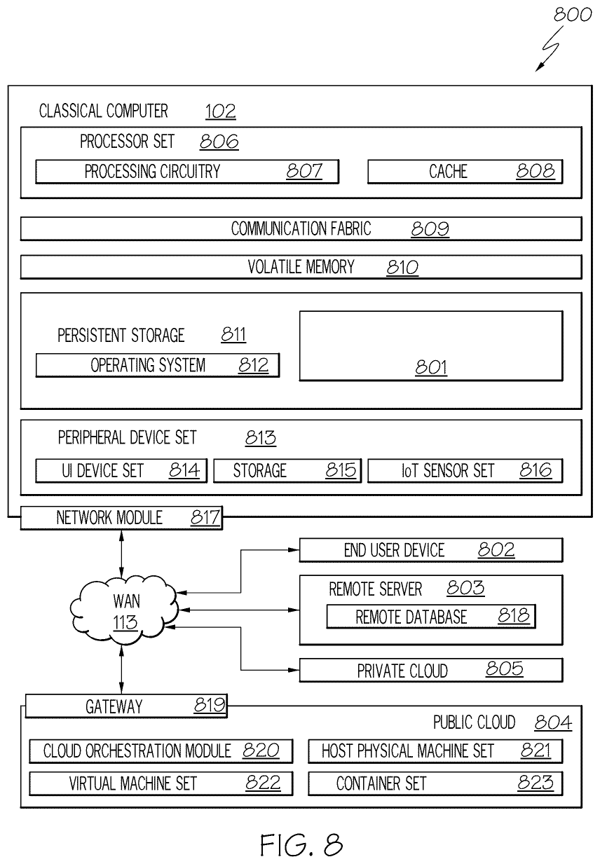

Furthermore, classical computer 102 is configured to perform quantum circuit routing using machine learning in a manner that modifies the quantum circuit to have a low gate count which minimizes the impact of noise thereby enabling error mitigation to be performed or to obtain better results in cases where error mitigation is not possible as discussed further below in connection with FIGS. 2-7 and 9-11. A description of the software components of classical computer 102 is provided below in connection with FIG. 2 and a description of the hardware configuration of classical computer 102 is provided further below in connection with FIG. 8.

System 100 is not to be limited in scope to any one particular network architecture. System 100 may include any number of quantum computers 101, classical computers 102, and networks 113.

A discussion regarding the software components used by classical computer 102 for performing quantum circuit routing using machine learning in a manner that modifies the quantum circuit to have a low gate count which minimizes the impact of noise thereby enabling error mitigation to be performed or to obtain better results in cases where error mitigation is not possible is provided below in connection with FIG. 2.

FIG. 2 is a diagram of the software components of classical computer 102 (FIG. 1) for performing quantum circuit routing using machine learning in a manner that modifies the quantum circuit to have a low gate count which minimizes the impact of noise thereby enabling error mitigation to be performed or to obtain better results in cases where error mitigation is not possible in accordance with an embodiment of the present disclosure.

Referring to FIG. 2, in conjunction with FIG. 1, classical computer 102 includes machine learning engine 201 configured to train a machine learning model to route a quantum circuit based on pre-processing the structure of the quantum circuit to route to reduce the number of SWAP gates and minimizing the cost function encoding the structure of the quantum circuit to route and the noise of a built routed quantum circuit. In one embodiment, such training is performed using reinforcement learning.

Routing a quantum circuit, as used herein, refers to the process of modifying a quantum circuit so that it meets the connectivity requirements of the target quantum processor. Such a process involves inserting SWAP gates (gate that swaps the states of two qubits), which are used to reposition logical qubits so that they are adjacent to each other. This allows the logical gates to only occur between adjacent physical qubits. Furthermore, such a process involves minimizing the circuit depth (count of the time steps needed to execute all the gates in the quantum circuit), such as minimizing the amount of circuit depth added by the SWAP gates.

Pre-processing the structure of the quantum circuit, as used herein, refers to steps performed by the trained machine learning model to reduce the number of SWAP gates based on the structure of the quantum circuit before performing quantum circuit routing based on minimizing the cost function.

A cost function, as used herein, refers to a mathematical function that measures how well the predictions of the machine learning model (e.g., neural network) align with the actual target values. That is, it quantifies the error between the predicted outputs and the true outputs.

In one embodiment, machine learning engine 201 trains a machine learning model (e.g., neural network) using reinforcement learning. Reinforcement learning, as used herein, refers to a machine learning technique that teaches software how to make decisions to achieve the best outcome. For example, reinforcement learning algorithms use a reward-and-punishment paradigm to learn from the feedback of each action. For instance, software actions that help achieve a goal are reinforced via rewards (a numerical value that a reinforcement learning agent receives after taking an action in a specific state of its environment) and software actions that hinder the goal are ignored and/or penalized. Such software actions are performed by a reinforcement learning agent (software entity that uses trial and error to learn how to make decisions and maximize rewards in an environment) in a dynamic environment (model or simulation that a reinforcement learning agent interacts with to learn how to complete a task).

In one embodiment, machine learning engine 201 updates the weights in the machine learning model (e.g., neural network) based on the history of the rewards (obtained from the cost function) that a reinforcement learning agent received for decisions taken, such as while playing multiple instances of a game (e.g., game to route the quantum circuit).

Weights, as used herein, refer to the learnable parameters that represent the strength of connections, such as between neurons or units in a neural network. That is, weights control the signal strength between the neurons and determine how much an input will affect an output. During training, the machine learning model adjusts the weights to optimize its performance.

A game, as used herein, refers to the controlled environment where reinforcement learning agent 202 of classical computer 102 learns to make decisions and complete goals by interacting with the game.

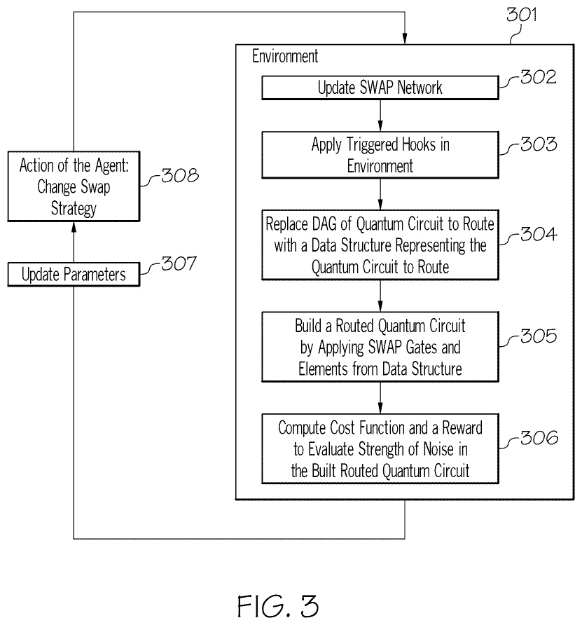

In one embodiment, training the machine learning model to perform quantum circuit routing to reduce the number of SWAP gates in the structure of the quantum circuit to route based on a reinforcement learning approach is illustrated in FIG. 3.

FIG. 3 is a diagram of training the machine learning model to reduce the number of SWAP gates in the structure of the quantum circuit based on a reinforcement learning approach involving a single-round game in accordance with an embodiment of the present disclosure.

Referring to FIG. 3, in conjunction with FIG. 2, reinforcement learning agent 202 (also referred to herein as simply “agent”) updates the parameters (weights) in the machine learning model (e.g., neural network weights, q-values in reinforcement learning without a neural network) based on the rewards received by agent 202 for the actions taken in an environment 301.

For example, agent 202 performs various actions in environment 301 as designated by elements 302-306. For instance, agent 202 performs the action of updating the SWAP network (see element 302), such as updating the network of SWAP gates. A network of SWAP gates, as used herein, refers to a sequence of SWAP gates that efficiently generates interactions between qubits. Furthermore, it is noted that a network of SWAP gates may correspond to a single SWAP gate.

Furthermore, agent 202 applies the triggered hooks (allows developers to insert custom code into specific points of an existing software program's execution flow) in environment 301 as illustrated by element 303. For example, tasks, such as SAT mapping, are performed in environment 301. SAT mapping, as used herein, refers to a technique that uses Boolean satisfiability (SAT) solvers to find a valid mapping (mapping virtual qubits to physical qubits) for a quantum circuit. SAT mapping is used to find a mapping for a quantum circuit that uses a minimal number of SWAP gates. In one embodiment, the SAT solver is given a conjunctive normal form (CNF) (way of expressing a Boolean formula) as input and checks if it is satisfiable. If the result is satisfiable, then there is a valid mapping that uses no more than the specified number of SWAP gates.

Additionally, the reinforcement learning approach replaces the directed acyclic graph (DAG) of the quantum circuit to route with a data structure representing the quantum circuit to route, such that the data structure encodes the structure of the quantum circuit to route as illustrated in element 304. A DAG of the quantum circuit, as used herein, refers to a graph where each connection between nodes (called an edge) has a defined direction. In one embodiment, machine learning engine 201 obtains such a DAG of the quantum circuit using the DAGCircuit class within the qiskit.dagcircuit module of Qiskit®.

In one embodiment, the DAG of the quantum circuit to route is replaced by a data structure that encodes the structure of the quantum circuit to route. In one embodiment, the quantum circuit to route may be made of commuting two-qubit gates, e.g., CZ(0, 1)-CZ(0, 2)-CZ(2, 3), which are replaced by a mathematical set data structure representing the quantum circuit as an unordered set of gates, e.g., {(0, 1), (0, 2), (2, 3)}.

In one embodiment, the DAG of the quantum circuit is replaced with a data structure representing the quantum circuit to route via Trotterization (method for approximating the evolution of a quantum system over time) by approximating the evolution operator e^{-iHt} by successively applying a quantum gate.

Furthermore, the agent builds a routed quantum circuit by applying SWAP gates and elements from the data structure as illustrated in element 305.

Additionally, the reinforcement learning approach computes, by environment 301, the cost function and a reward to evaluate a strength of noise in the built routed quantum circuit as illustrated in element 306. For example, environment 301 computes a scoring function which evaluates the strength of the noise in the built routed quantum circuit based on a noise model of the quantum processing unit (e.g., quantum processor 108) of quantum computer 101.

Furthermore, in one embodiment, the SWAP gates applied by agent 202 are from layers of a network of SWAP gates optimized by agent 202. Additionally, in another embodiment, the choice of SWAP layers made by agent 202 are optimized in the reinforcement learning approach but the available set of SWAP layers to apply is fixed.

Furthermore, agent 202 receives a reward, which is obtained from the cost function (e.g., scoring function). Such a reward corresponds to a numerical value that agent 202 receives after taking an action in a specific state of its environment 301.

After computing the cost function and reword, the agent updates the parameters (weights) in the machine learning model (e.g., neural network weights, q-values in reinforcement learning without a neural network) based on the rewards received by agent 202 for the actions taken in environment 301 as illustrated by element 307. Such updated parameters (weights) are then utilized by agent 202 to perform the action of changing the SWAP strategy as illustrated by element 308. Such a change to the SWAP strategy involves how to update the SWAP network, which maps the logical operations to qubits that are physically adjacent.

FIG. 3 illustrates a “single-round game” in which agent 202 interacts with the environment (e.g., environment 301) only once, making a single decision and receiving a single reward. However, the principles of the present disclosure may encode the structure of the quantum circuit in an environment by training the machine learning model to reduce the number of SWAP gates in the structure of the quantum circuit while performing quantum circuit routing based on a reinforcement learning approach involving a multiple-round game. In a multiple-round game, the agent interacts with the environment (e.g., environment 301) multiple times within a single episode, making decisions and receiving rewards in each round, allowing for learning based on the cumulative experience across those rounds. For example, after the agent, such as agent 202, computes the cost function and a reward to evaluate the strength of the noise in the built routed quantum circuit, the agent continues to update the SWAP network, such as by applying one or more SWAP gates, until all SWAP gates are routed or has reached the maximum number of SWAP gates in the SWAP network.

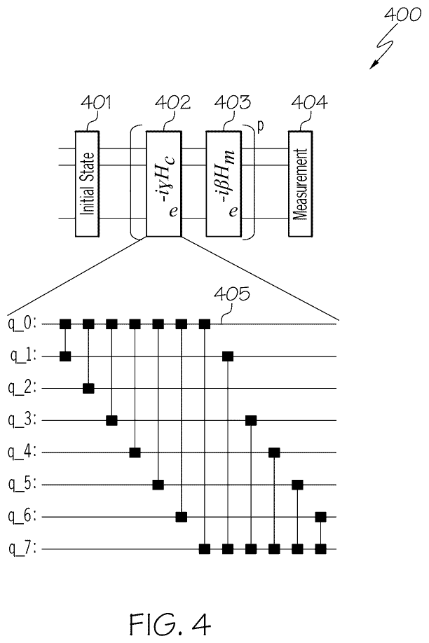

Furthermore, in connection with training the machine learning model to route the quantum circuit to reduce the number of SWAP gates leveraging the structure of the quantum circuit based on a reinforcement learning approach, the structure of the quantum circuit to route is encoded by encoding engine 203 of classical computer 102 within the environment (e.g., environment 301) in which the reinforcement learning agent is exposed. Such a structure of the quantum circuit may be specific to the type of quantum algorithm (e.g., quantum approximate optimization algorithm, Trotter simulations, generation of bell pairs serving as a building block for quantum computing applications, etc.). For example, such a structure may correspond to an unordered set of two-tuples (i, j), with i and j being qubit indices for the quantum approximate optimization algorithm as discussed further below in connection with FIG. 4.

A quantum approximate optimization algorithm, as used herein, is a hybrid quantum-classical algorithm that solves combinational optimization problems. For example, the quantum approximate optimization algorithm transforms a discrete optimization problem into a classical optimization problem over continuous circuit parameters.

In one embodiment, the quantum approximate optimization algorithm uses routing blocks of gates. The mixer (a unitary transformation that may introduce single-qubit rotations in a quantum state) e^{-iβH}^{_{M}} is typically made of local terms thereby enabling the ease of routing. Similarly, the initial state is typically made of local terms. However, the cost operator, e^{-iγH}^{_{C}}, which represents a classical cost function, is built from commuting gates R_{ZZ}(θᵢ). That is, the cost operator encodes the cost function to be optimized.

As a result, in order to route quantum approximate optimization algorithm circuits, only the cost operator e^{-iγH}^{_{C}} is represented in the reinforcement learning environment (e.g., environment 301 of FIG. 3). In one embodiment, the cost operator is represented as a flat set of edges on which gates act as opposed to the directed acyclic graph of gates.

Referring to FIG. 4, FIG. 4 illustrates encoding the structure of a quantum circuit for the quantum approximate optimization algorithm in a reinforcement learning environment in accordance with an embodiment of the present disclosure.

As shown in FIG. 4, structure 400 of the quantum circuit for the quantum approximate optimization algorithm includes an initial state 401, the cost operator 402, the mixer 403, and the measurement 404. As further illustrated in FIG. 4, instead of representing the cost operator 402 as a directed acyclic graph representation which arbitrarily enforces an order of the R_{ZZ} gates, the following representation {(1,7), (0,1), (6,7), (7,5), (0,2), (3,0), (0,4), (4,7), (5,0), (0,6), (3,7), (0,7)} is utilized by encoding engine 203 to represent the connections between the qubits in the reinforcement learning environment (e.g., environment 301 of FIG. 3) as shown in diagram 405. That is, the machine learning environment (e.g., environment 301 of FIG. 3) encodes such a representation, where the agent's task is to represent the cost operator in the reinforcement learning environment (e.g., environment 301 of FIG. 3) as a flat set of edges on which gates act.

Another example of a structure that corresponds to a specific type of quantum circuit algorithm involves Trotter simulations. A Trotter simulation, as used herein, is a method for simulating quantum systems using the Trotter formula, which breaks down a unitary time evolution into a series of repeated evolutions.

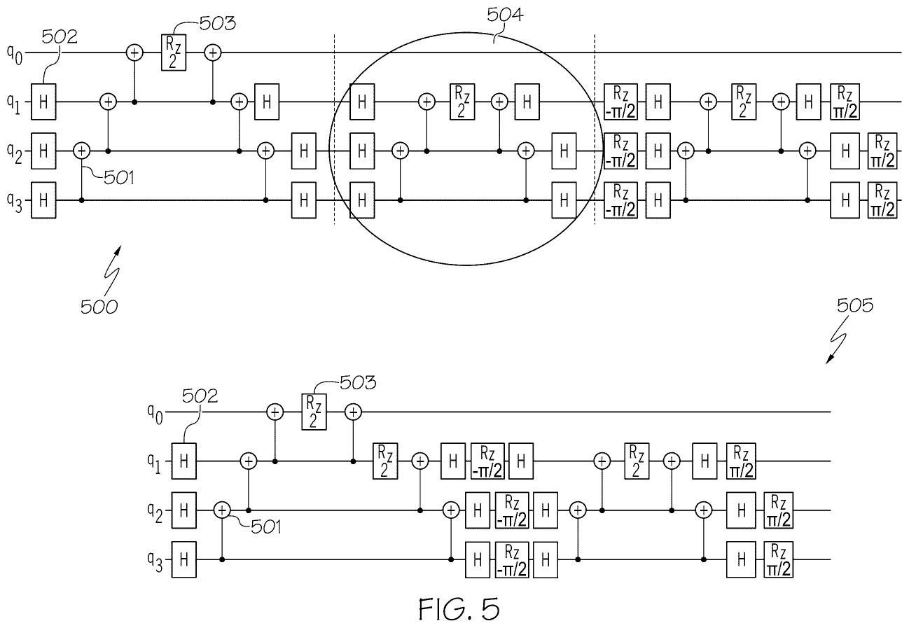

In one embodiment, encoding engine 203 encodes the structure of a quantum circuit corresponding to Trotter simulations in the reinforcement learning environment (e.g., environment 301) as discussed below in connection with FIG. 5.

Referring to FIG. 5, FIG. 5 illustrates encoding the structure of a quantum circuit for Trotter simulations in a reinforcement learning environment in accordance with an embodiment of the present disclosure.

In Trotter, the time evolution operator, e^{-itH}, needs to be implanted with H=ΣaᵢPᵢ, a sum of Pauli strings. For example, consider P₁=XXXZ(op1), P₂=XXXI(op2), P₃=YYYI (op3), where X (corresponds to a bit flip operation), Y (represents a combination of bit flip and phase flip), Z (changes the phase of a qubit depending on its stat) and I (represents the “do nothing” operation), are the Pauli operators, and op1, op2, and op3 represent the operations.

Trotter creates ladders of CX gates that cancel if the order of the Pᵢ's is chosen wisely. A CX gate, as used herein, refers to a controlled-X gate, which is a quantum logic gate that acts on two qubits. A “ladder” of CX gates refers to a diagonal structure of CX gates that has a depth of n, where n is the number of qubits in the ladder of CX gates.

As shown in FIG. 5, the diagram of quantum circuit 500 includes CX gates 501, Hadamard gates 502, and Rz gates 503. As further shown in FIG. 5, Trotter creates ladders of CX gates (e.g., CX ladder 504) that may cancel if the order of the Pᵢ's is chosen wisely. For example, the Pauli strings of XXXZ, XXXI, YYYI results in the cancellation of CX ladder 504 after the transpilation of quantum circuit 500 resulting in transpiled quantum circuit 505. Transpilation, as used herein, refers to the process of rewriting a given input circuit to match the topology of a specific quantum device and optimizing the circuit instructions for execution on a noisy quantum computer (e.g., quantum computer 101).

In one embodiment, the machine learning environment (e.g., environment 301 of FIG. 3) encodes the Pauli's as a set {P₀, P₁, P₂, . . . }. The agent's task is first to find the order of the Pauli's which produces the maximum number of CX ladder cancellations.

Furthermore, in one embodiment, encoding engine 203 encodes the noise of the quantum circuit (e.g., built routed quantum circuit) in a cost function. Noise, as used herein, refers to the unwanted perturbations or errors that occur during the execution of gates (e.g., two-qubit gates) causing the quantum state of the qubits to deviate from the intended ideal state due to interaction with the environment or imperfections in the physical hardware potentially leading to incorrect computation results.

In one embodiment, encoding engine 203 encodes the noise of the built routed quantum circuit in the cost function by measuring the noise in the layer(s) of the gates (e.g., two-qubit gates) of the quantum circuit.

For example, in one embodiment, encoding engine 203 encodes the noise of the built routed quantum circuit in the cost function using a naïve approach to minimize the gate count and gate depth in a circuit, C. As a result, the cost function may be represented as f (C)=aN_{CX}+bN_{layers}, where N_{CX} and N_{layers} are the number of CX gates (two-qubit gates) and the number of layers of the two-qubit gates, respectively. The parameters a and b of the model are then tuned.

In one embodiment, encoding engine 203 encodes the noise of the built routed quantum circuit in the cost function by formulating the cost function based on the γ (measure of the amount of noise in a layer of two-qubit gates) cost of the layers of the two-qubit gates. In one embodiment, the amount of noise in a layer of two-qubit gates is obtained by encoding engine 203 via probabilistic error cancellation, in which the noise of the layers of gates is first learned. In one embodiment, encoding engine 203 uses various software tools for performing probabilistic error cancellation, including, but are not limited to, Mitiq, Qiskit®, etc.

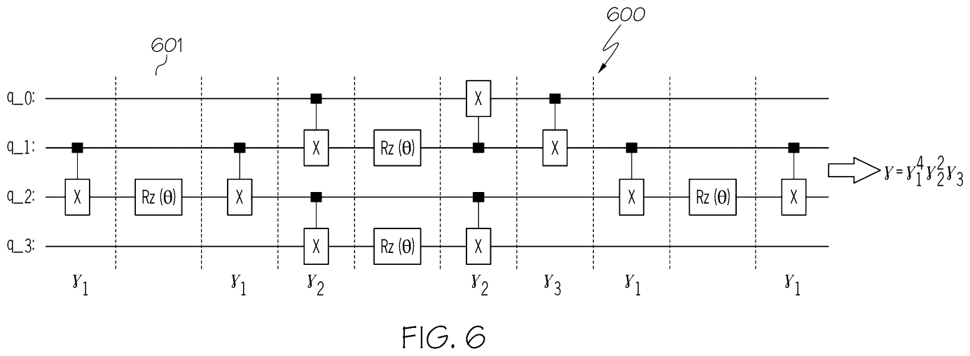

For example, as shown in FIG. 6, the noise cost of the layers of the two-qubit gates are used to form the cost function.

FIG. 6 illustrates encoding the noise of the quantum circuit in a cost function in accordance with an embodiment of the present disclosure.

Referring to FIG. 6, the noise cost (Y) for each of the layers 601 of quantum circuit 600 are acquired by a noise model, such as by performing probabilistic error cancellation. As illustrated in FIG. 6, the noise cost (Y) for each of the layers 601 of quantum circuit 600 corresponds to γ₁, γ₁, γ₂, γ₂, γ₃, γ₁, γ₁ resulting in the cost function

$$γ = {γ}_{1}^{4} {γ}_{2}^{2} {γ}_{3} .$$

In one embodiment, encoding engine 203 encodes the noise of the built routed quantum circuit in the cost function by estimating the γ-based cost function.

In such an embodiment, the quantum circuit is transpiled into layers of hardware native gates. The total γ of the quantum circuit is estimated as the product of the γᵢ of layer i.

In one embodiment, measuring the γᵢ of each layer is performed by splitting the training into multiple steps. First, the γ is estimated in a model, e.g., from known quantities such as the two-qubit gate error (e.g., γᵢ=Πⱼ(1+E_{cx,j}) with E_{cx,j}, the error of two-qubit gate j in layer i). Errors, such as crosstalk, will be neglected.

Secondly, once the training is more advanced, the model of γ can be refined by measuring on the target quantum hardware the γᵢ of the most probable layers of gates used by the machine learning in order to capture static and dynamic crosstalk. Static crosstalk, as used herein, refers to the type of crosstalk that is always present in hardware platforms, such as semiconductor and superconductor qubits. It is caused by the constant coupling between qubits. Dynamic crosstalk, as used herein, refers to the type of crosstalk that occurs when leakage from driven gates on other qubits creates an unwanted drive term. For those layers where γᵢ were not measured, such γᵢ can be inferred from the other layers that were measured.

As a result, the γ-based cost function enables the capture of additional sources of noise that would not be captured using an approach, such as the naïve approach. As a result, in one embodiment, the machine learning methods are noise aware. Furthermore, the γ-based cost function enables the overhead of error mitigation (e.g., probabilistic error cancellation, probabilistic error amplification) to be minimized.

Classical computer 102 further includes transpilation service 204 configured to receive the structure of the quantum circuit to be routed. In one embodiment, such a structure is received from a user, such as a user of classical computer 102. In one embodiment, such a structure is inferred, such as from the circuit attributes of the quantum circuit. For example, such attributes can be obtained via the QuantumCircuit class of Qiskit®.

In one embodiment, such a structure of the quantum circuit to be routed corresponds to the structure of the quantum circuit that was encoded in the reinforcement learning environment by encoding engine 203.

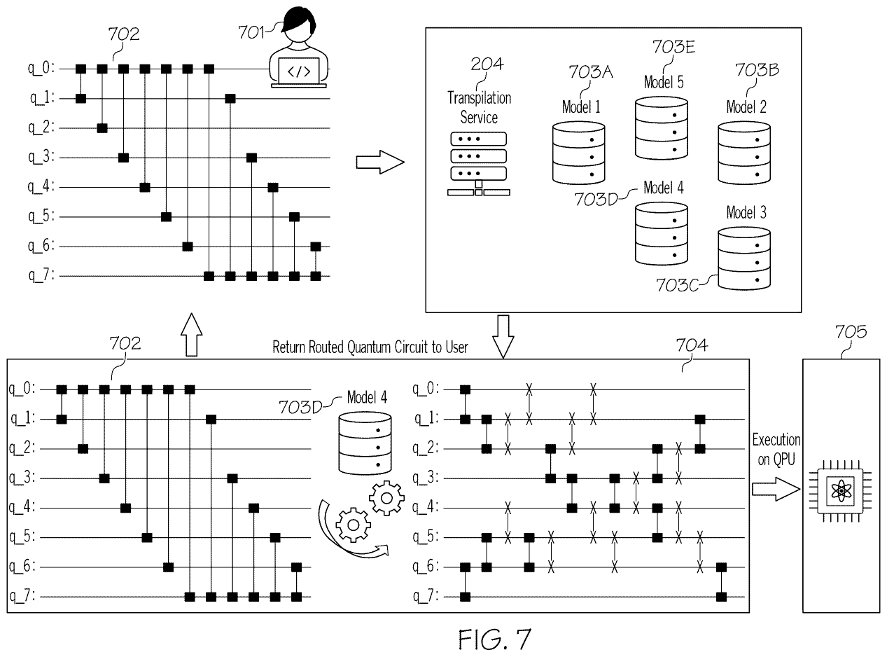

In one embodiment, transpilation service 204 selects a trained machine learning model out of multiple trained machine learning models based on the received structure of the quantum circuit as illustrated in FIG. 7.

FIG. 7 illustrates routing the quantum circuit using a selected trained machine learning model in accordance with an embodiment of the present disclosure.

Referring to FIG. 7, a user 701 communicates to transpilation service 204 regarding performing quantum circuit routing. Transpilation service 204 as used herein, refers to a service that performs transpilation, such as via transpiler 112. In one embodiment, user 701 provides the structure 702 of the quantum circuit to be routed, such as via the user interface of classical computer 102.

In one embodiment, based on the structure of the quantum circuit, which may be inferred, such as by transpilation service 204, transpilation service 204 selects one of the trained machine learning models 703A-703E (labeled as “Model 1,” “Model 2,” “Model 3,” “Model 4,” and “Model 5,” respectively). Machine learning models 703A-703E may collectively or individually be referred to as machine learning models 703 or machine learning model 703, respectively. Machine learning models 703, as used herein, refer to a machine learning model that has been trained to route the quantum circuit by pre-processing the structure of the quantum circuit to route to reduce the number of SWAP gates and minimizing the cost function encoding the structure of the quantum circuit to route and the noise of a built routed quantum circuit.

In one embodiment, each machine learning model 703 is associated with a type of structure of a quantum circuit that the machine learning model 703 was trained to route. For example, each machine learning model 703 may have been trained to route a structure of the quantum circuit for a particular type of quantum algorithm. For instance, machine learning model 703A may have been trained to route a structure of the quantum circuit for the quantum approximate optimization algorithm. Machine learning model 703B may have been trained to route a structure of the quantum circuit for Trotter simulations. Machine learning model 703C may have been trained to route a structure of the quantum circuit for the generation of bell pairs serving as a building block for quantum computing applications and so forth.

In one embodiment, transpilation service 204 selects one of the trained machine learning models 703 based on identifying machine learning model 703 that has been trained to route a structure that most closely matches structure 702, which may be inferred by transpilation service 204, of the quantum circuit to be routed. In one embodiment, the structures upon which machine learning models 703 have been trained are stored in a data structure (e.g., table). Such a data structure may include a listing of structures and the corresponding machine learning models 703 which have been trained to route such associated structures. In one embodiment, transpilation server 204 performs a lookup in such a data structure to identify the structure that most closely matches structure 702, where machine learning model 703 associated with the identified structure is selected to perform quantum circuit routing on the received quantum circuit. In one embodiment, such a data structure resides within the storage device of classical computer 102. In one embodiment, such a data structure is populated by an expert.

In one embodiment, transpilation service 204 determines which structure in the data structure, associated with a trained machine learning model 703, most closely matches structure 702 of the quantum circuit to be routed using a pattern-matching algorithm that analyzes the sequences and types of quantum gates within each circuit, considering factors, such as qubit connectivity, gate parameters, and commutation rules, to identify similarities and potential equivalences between them. In one embodiment, such a pattern-matching algorithm utilizes subgraph isomorphism to identify circuit patterns within larger quantum circuits. In one embodiment, such a pattern-matching algorithm utilizes heuristic methods to identify approximate matches based on key features of the structures.

In one embodiment, transpilation service 204 utilizes various pattern matching algorithms to perform pattern-matching for selecting the most appropriate trained machine learning model for performing the quantum circuit routing based on identifying a structure in the data structure, associated with a trained machine learning model 703, that most closely matches structure 702 of the quantum circuit to be routed. Examples of such pattern matching algorithms include, but are not limited to, naïve pattern matching, Knuth-Morris-Pratt (KMP), Boyer-Moore, dynamic programming based approaches, etc.

Upon selecting the appropriate trained machine learning model (e.g., machine learning model 703D) to perform quantum circuit routing, transpilation service 204 performs quantum circuit routing using the selected trained machine learning model based on pre-processing the structure of the quantum circuit as shown by element 704 to reduce the number of SWAP gates and minimizing the cost function which reduces the gate count and noise since the structure and noise are encoded in the cost function. The output of the selected machine learning model may then be returned to user 701 or executed on hardware, such as executed on the quantum processing unit (QPU) 705 (e.g., quantum processor 108 of FIG. 1) of quantum computer 101 of FIG. 1.

In this manner, the routing of the quantum circuit is performed in a manner that modifies the quantum circuit to have a low gate count which minimizes the impact of noise thereby enabling error mitigation to be performed or to obtain better results in cases where error mitigation is not possible.

A further description of these and other functions is provided below in connection with the discussion of the method for performing quantum circuit routing using machine learning in a manner that modifies the quantum circuit to have a low gate count which minimizes the impact of noise.

Prior to the discussion of the method for performing quantum circuit routing using machine learning in a manner that modifies the quantum circuit to have a low gate count which minimizes the impact of noise, a description of the hardware configuration of classical computer 102 (FIG. 1) is provided below in connection with FIG. 8.

Referring now to FIG. 8, in conjunction with FIG. 1, FIG. 8 illustrates an embodiment of the present disclosure of the hardware configuration of classical computer 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 800 contains an example of an environment for the execution of at least some of the computer code 801 involved in performing the inventive methods, such as performing quantum circuit routing using machine learning in a manner that modifies the quantum circuit to have a low gate count which minimizes the impact of noise. In addition to block 801, computing environment 800 includes, for example, classical computer 102, network 113, such as a wide area network (WAN), end user device (EUD) 802, remote server 803, public cloud 804, and private cloud 805. In this embodiment, classical computer 102 includes processor set 806 (including processing circuitry 807 and cache 808), communication fabric 809, volatile memory 810, persistent storage 811 (including operating system 812 and block 801, as identified above), peripheral device set 813 (including user interface (UI) device set 814, storage 815, and Internet of Things (IoT) sensor set 816), and network module 817. Remote server 803 includes remote database 818. Public cloud 804 includes gateway 819, cloud orchestration module 820, host physical machine set 821, virtual machine set 822, and container set 823.

Classical computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 818. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically classical computer 102, to keep the presentation as simple as possible. Classical computer 102 may be located in a cloud, even though it is not shown in a cloud in FIG. 8. On the other hand, classical computer 102 is not required to be in a cloud except to any extent as may be affirmatively indicated.

Processor set 806 includes one, or more, computer processors of any type now known or to be developed in the future. Processing circuitry 807 may be distributed over multiple packages, for example, multiple, coordinated integrated circuit chips. Processing circuitry 807 may implement multiple processor threads and/or multiple processor cores. Cache 808 is memory that is located in the processor chip package(s) and is typically used for data or code that should be available for rapid access by the threads or cores running on processor set 806. Cache memories are typically organized into multiple levels depending upon relative proximity to the processing circuitry. Alternatively, some, or all, of the cache for the processor set may be located “off chip.” In some computing environments, processor set 806 may be designed for working with qubits and performing quantum computing.

Computer readable program instructions are typically loaded onto classical computer 102 to cause a series of operational steps to be performed by processor set 806 of classical computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 808 and the other storage media discussed below. The program instructions, and associated data, are accessed by processor set 806 to control and direct performance of the inventive methods. In computing environment 800, at least some of the instructions for performing the inventive methods may be stored in block 801 in persistent storage 811.

Communication fabric 809 is the signal conduction paths that allow the various components of classical computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 810 is any type of volatile memory now known or to be developed in the future. Examples include dynamic type random access memory (RAM) or static type RAM. Typically, the volatile memory is characterized by random access, but this is not required unless affirmatively indicated. In classical computer 102, the volatile memory 810 is located in a single package and is internal to classical computer 102, but, alternatively or additionally, the volatile memory may be distributed over multiple packages and/or located externally with respect to classical computer 102.

Persistent Storage 811 is any form of non-volatile storage for computers that is now known or to be developed in the future. The non-volatility of this storage means that the stored data is maintained regardless of whether power is being supplied to classical computer 102 and/or directly to persistent storage 811. Persistent storage 811 may be a read only memory (ROM), but typically at least a portion of the persistent storage allows writing of data, deletion of data and re-writing of data. Some familiar forms of persistent storage include magnetic disks and solid state storage devices. Operating system 812 may take several forms, such as various known proprietary operating systems or open source Portable Operating System Interface type operating systems that employ a kernel. The code included in block 801 typically includes at least some of the computer code involved in performing the inventive methods.

Peripheral device set 813 includes the set of peripheral devices of classical computer 102. Data communication connections between the peripheral devices and the other components of classical computer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 814 may include components such as a display screen, speaker, microphone, wearable devices (such as goggles and smart watches), keyboard, mouse, printer, touchpad, game controllers, and haptic devices. Storage 815 is external storage, such as an external hard drive, or insertable storage, such as an SD card. Storage 815 may be persistent and/or volatile. In some embodiments, storage 815 may take the form of a quantum computing storage device for storing data in the form of qubits. In embodiments where classical computer 102 is required to have a large amount of storage (for example, where classical computer 102 locally stores and manages a large database) then this storage may be provided by peripheral storage devices designed for storing very large amounts of data, such as a storage area network (SAN) that is shared by multiple, geographically distributed computers. IoT sensor set 816 is made up of sensors that can be used in Internet of Things applications. For example, one sensor may be a thermometer and another sensor may be a motion detector.

Network module 817 is the collection of computer software, hardware, and firmware that allows classical computer 102 to communicate with other computers through WAN 113. Network module 817 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 817 are performed on the same physical hardware device. In other embodiments (for example, embodiments that utilize software-defined networking (SDN)), the control functions and the forwarding functions of network module 817 are performed on physically separate devices, such that the control functions manage several different network hardware devices. Computer readable program instructions for performing the inventive methods can typically be downloaded to classical computer 102 from an external computer or external storage device through a network adapter card or network interface included in network module 817.

WAN 113 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 802 is any computer system that is used and controlled by an end user (for example, a customer of an enterprise that operates classical computer 102), and may take any of the forms discussed above in connection with classical computer 102. EUD 802 typically receives helpful and useful data from the operations of classical computer 102. For example, in a hypothetical case where classical computer 102 is designed to provide a recommendation to an end user, this recommendation would typically be communicated from network module 817 of classical computer 102 through WAN 113 to EUD 802. In this way, EUD 802 can display, or otherwise present, the recommendation to an end user. In some embodiments, EUD 802 may be a client device, such as thin client, heavy client, mainframe computer, desktop computer and so on.

Remote server 803 is any computer system that serves at least some data and/or functionality to classical computer 102. Remote server 803 may be controlled and used by the same entity that operates classical computer 102. Remote server 803 represents the machine(s) that collect and store helpful and useful data for use by other computers, such as classical computer 102. For example, in a hypothetical case where classical computer 102 is designed and programmed to provide a recommendation based on historical data, then this historical data may be provided to classical computer 102 from remote database 818 of remote server 803.

Public cloud 804 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 804 is performed by the computer hardware and/or software of cloud orchestration module 820. The computing resources provided by public cloud 804 are typically implemented by virtual computing environments that run on various computers making up the computers of host physical machine set 821, which is the universe of physical computers in and/or available to public cloud 804. The virtual computing environments (VCEs) typically take the form of virtual machines from virtual machine set 822 and/or containers from container set 823. It is understood that these VCEs may be stored as images and may be transferred among and between the various physical machine hosts, either as images or after instantiation of the VCE. Cloud orchestration module 820 manages the transfer and storage of images, deploys new instantiations of VCEs and manages active instantiations of VCE deployments. Gateway 819 is the collection of computer software, hardware, and firmware that allows public cloud 804 to communicate through WAN 113.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 805 is similar to public cloud 804, except that the computing resources are only available for use by a single enterprise. While private cloud 805 is depicted as being in communication with WAN 113 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 804 and private cloud 805 are both part of a larger hybrid cloud.

Block 801 further includes the software components discussed above in connection with FIGS. 2-7 to perform quantum circuit routing using machine learning in a manner that modifies the quantum circuit to have a low gate count which minimizes the impact of noise. In one embodiment, such components may be implemented in hardware. The functions discussed above performed by such components are not generic computer functions. As a result, classical computer 102 is a particular machine that is the result of implementing specific, non-generic computer functions.

In one embodiment, the functionality of such software components of classical computer 102, including the functionality for performing quantum circuit routing using machine learning in a manner that modifies the quantum circuit to have a low gate count which minimizes the impact of noise, may be embodied in an application specific integrated circuit.

As stated above, quantum circuit routing is the process of modifying a quantum circuit so that it meets the connectivity requirements of a target quantum processor. Such a process involves mapping virtual qubits to physical qubits, commonly referred to as a layout. Furthermore, such a process involves inserting SWAP gates (gate that swaps the states of two qubits), which are used to reposition logical qubits so that they are adjacent to each other. This allows the logical gates to only occur between adjacent physical qubits. Additionally, such a process involves minimizing circuit depth (count of the time steps needed to execute all the gates in the quantum circuit). The goal is to minimize the amount of circuit depth added by the SWAP gates. When routing quantum circuits, there are various factors that need to be taken into consideration. For example, not all qubits are connected. Some qubits can be far apart on the chip. Furthermore, SWAP gates are costly and prone to errors. As a result, it is best to avoid using too many SWAP gates. Furthermore, quantum systems are prone to errors and noise, which can affect the accuracy and reliability of quantum circuit routing. For example, quantum hardware is noisy emanating from noise sources, such as energy loss during idle times, loss of coherence in quantum states, static crosstalk (e.g., type of unwanted coupling between qubits that occurs due to always-on qubit-qubit coupling), dynamic crosstalk (e.g., gate induced crosstalk where a gate disturbs neighboring gates or qubits), etc. Algorithms, such as quantum routing algorithms, may be utilized to route quantum circuits. Several quantum routing algorithms include noise in either heuristic algorithms or formal models. Unfortunately, such heuristic algorithms are typically sub-optimal (difficulty in identifying circuits with low gate counts) and perform poorly involving quantum circuits with given symmetries or structures. Furthermore, such formal models do not scale beyond a handful of qubits. In the process of routing quantum circuits, it is desirable to modify the quantum circuit to have a low gate count which minimizes the impact of noise. By minimizing the impact of noise, it makes it easier to perform error mitigation as well as obtain better results in cases where error mitigation is not possible (e.g., sampling-based problems, such as combinational optimization). Unfortunately, current quantum routing algorithms are deficient in routing quantum circuits by modifying the quantum circuit to have a low gate count which minimizes the impact of noise.

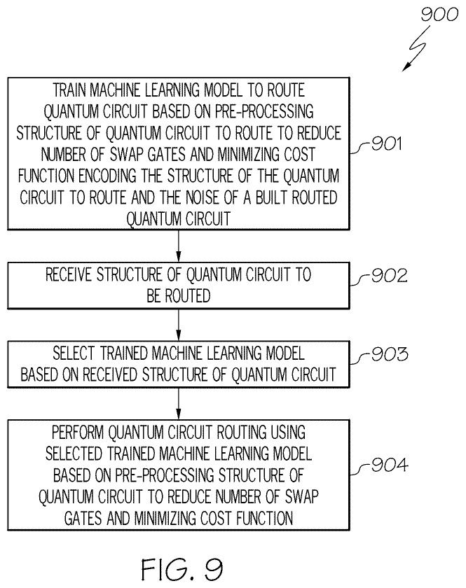

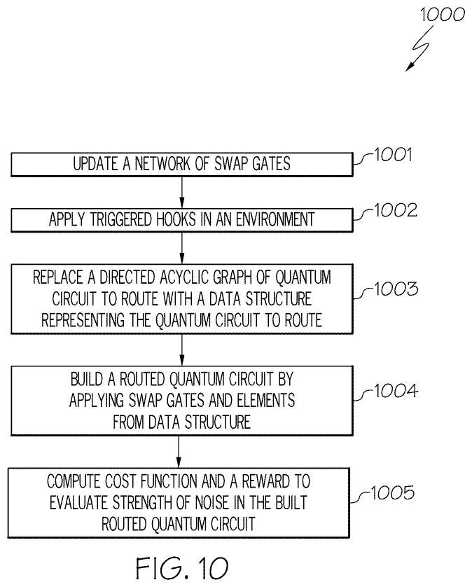

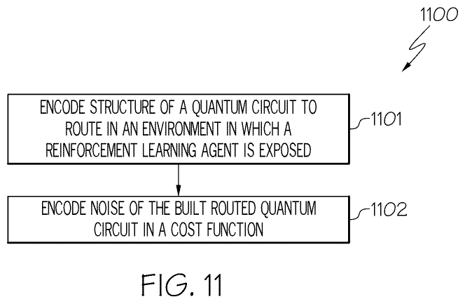

The embodiments of the present disclosure provide the means for performing quantum circuit routing using machine learning in a manner that modifies the quantum circuit to have a low gate count which minimizes the impact of noise as discussed below in connection with FIGS. 9-11. FIG. 9 is a flowchart of a method for performing quantum circuit routing using machine learning in a manner that modifies the quantum circuit to have a low gate count which minimizes the impact of noise. FIG. 10 is a flowchart of a method for training the machine learning model to reduce the number of SWAP gates in the structure of the quantum circuit to route based on a reinforcement learning approach involving a single-round game. FIG. 11 is a flowchart of a method for encoding the structure of the quantum circuit to route and the noise of the built routed quantum circuit in a cost function.

As stated above, FIG. 9 is a flowchart of a method 900 for performing quantum circuit routing using machine learning in a manner that modifies the quantum circuit to have a low gate count which minimizes the impact of noise in accordance with an embodiment of the present disclosure.

Referring to FIG. 9, in conjunction with FIGS. 1-8, in step 901, machine learning engine 201 of classical computer 102 trains a machine learning model to route a quantum circuit based on pre-processing the structure of the quantum circuit to route to reduce the number of SWAP gates and minimizing the cost function encoding the structure of the quantum circuit to route and the noise of a built routed quantum circuit.

As discussed above, in one embodiment, such training is performed using reinforcement learning.

Routing a quantum circuit, as used herein, refers to the process of modifying a quantum circuit so that it meets the connectivity requirements of the target quantum processor. Such a process involves inserting SWAP gates (gate that swaps the states of two qubits), which are used to reposition logical qubits so that they are adjacent to each other. This allows the logical gates to only occur between adjacent physical qubits. Furthermore, such a process involves minimizing the circuit depth (count of the time steps needed to execute all the gates in the quantum circuit), such as minimizing the amount of circuit depth added by the SWAP gates.

Pre-processing the structure of the quantum circuit, as used herein, refers to steps performed by the trained machine learning model to reduce the number of SWAP gates based on the structure of the quantum circuit before performing quantum circuit routing based on minimizing the cost function.

A cost function, as used herein, refers to a mathematical function that measures how well the predictions of the machine learning model (e.g., neural network) align with the actual target values. That is, it quantifies the error between the predicted outputs and the true outputs.

In one embodiment, machine learning engine 201 trains a machine learning model (e.g., neural network) using reinforcement learning. Reinforcement learning, as used herein, refers to a machine learning technique that teaches software how to make decisions to achieve the best outcome. For example, reinforcement learning algorithms use a reward-and-punishment paradigm to learn from the feedback of each action. For instance, software actions that help achieve a goal are reinforced via rewards (a numerical value that a reinforcement learning agent receives after taking an action in a specific state of its environment) and software actions that hinder the goal are ignored and/or penalized. Such software actions are performed by a reinforcement learning agent (software entity that uses trial and error to learn how to make decisions and maximize rewards in an environment) in a dynamic environment (model or simulation that a reinforcement learning agent interacts with to learn how to complete a task).

In one embodiment, machine learning engine 201 updates the weights in the machine learning model (e.g., neural network) based on the history of the rewards (obtained from the cost function) that a reinforcement learning agent received for decisions taken, such as while playing multiple instances of a game (e.g., game to route the quantum circuit).

Weights, as used herein, refer to the learnable parameters that represent the strength of connections, such as between neurons or units in a neural network. That is, weights control the signal strength between the neurons and determine how much an input will affect an output. During training, the machine learning model adjusts the weights to optimize its performance.

A game, as used herein, refers to the controlled environment where the reinforcement learning agent learns to make decisions and complete goals by interacting with the game.

In one embodiment, the machine learning model is trained to route the quantum circuit in a manner that reduces the number of SWAP gates in the structure of the quantum circuit to route based on a reinforcement learning approach involving a single-round game as discussed below in connection with FIG. 10.

FIG. 10 is a flowchart of a method 1000 for training the machine learning model to reduce the number of SWAP gates in the structure of the quantum circuit to route based on a reinforcement learning approach involving a single-round game in accordance with an embodiment of the present disclosure.

Referring to FIG. 10, in conjunction with FIGS. 1-9, in step 1001, reinforcement learning agent 202 (also referred to herein as simply “agent”) of classical computer 102 updates a network of SWAP gates in environment 301 as illustrated by element 302 of FIG. 3. A network of SWAP gates, as used herein, refers to a sequence of SWAP gates that efficiently generates interactions between qubits. Furthermore, it is noted that a network of SWAP gates may correspond to a single SWAP gate.

In step 1002, agent 202 of classical computer 102 applies the triggered hooks (allows developers to insert custom code into specific points of an existing software program's execution flow) in environment 301 as illustrated by element 303 of FIG. 3.

As stated above, for example, tasks, such as SAT mapping, are performed in environment 301. SAT mapping, as used herein, refers to a technique that uses Boolean satisfiability (SAT) solvers to find a valid mapping (mapping virtual qubits to physical qubits) for a quantum circuit. SAT mapping is used to find a mapping for a quantum circuit that uses a minimal number of SWAP gates. In one embodiment, the SAT solver is given a conjunctive normal form (CNF) (way of expressing a Boolean formula) as input and checks if it is satisfiable. If the result is satisfiable, then there is a valid mapping that uses no more than the specified number of SWAP gates.

In step 1003, the reinforcement learning approach replaces the directed acyclic graph (DAG) of the quantum circuit to route with a data structure representing the quantum circuit to route, such that the data structure encodes the structure of the quantum circuit to route as illustrated in element 304.

As discussed above, a DAG of the quantum circuit, as used herein, refers to a graph where each connection between nodes (called an edge) has a defined direction. In one embodiment, machine learning engine 201 obtains such a DAG of the quantum circuit using the DAGCircuit class within the qiskit.dagcircuit module of Qiskit®.

In one embodiment, the DAG of the quantum circuit to route is replaced by a data structure that encodes the structure of the quantum circuit to route. In one embodiment, the quantum circuit to route may be made of commuting two-qubit gates, e.g., CZ(0, 1)-CZ(0, 2)-CZ(2, 3), which are replaced by a mathematical set data structure representing the quantum circuit as an unordered set of gates, e.g., {(0, 1), (0, 2), (2, 3)}.

In one embodiment, the DAG of the quantum circuit is replaced with a data structure representing the quantum circuit to route via Trotterization (method for approximating the evolution of a quantum system over time) by approximating the evolution operator e^{-iHt} by successively applying a quantum gate.

In step 1004, agent 202 of classical computer 102 builds a routed quantum circuit by applying SWAP gates and elements from the data structure as illustrated in element 305.

In step 1005, the reinforcement learning approach computes, by environment 301, the cost function and a reward to evaluate a strength of noise in the built routed quantum circuit as illustrated in element 306.

As stated above, for example, environment 301 computes a scoring function which evaluates the strength of the noise in the built routed quantum circuit based on a noise model of the quantum processing unit (e.g., quantum processor 108) of quantum computer 101.

Furthermore, in one embodiment, the SWAP gates applied by agent 202 are from layers of a network of SWAP gates optimized by agent 202. Additionally, in another embodiment, the choice of SWAP layers made by agent 202 are optimized in the reinforcement learning approach but the available set of SWAP layers to apply is fixed.

Furthermore, agent 202 receives a reward, which is obtained from the cost function (e.g., scoring function). Such a reward corresponds to a numerical value that agent 202 receives after taking an action in a specific state of its environment 301.

After computing the cost function and reword, the agent updates the parameters (weights) in the machine learning model (e.g., neural network weights, q-values in reinforcement learning without a neural network) based on the rewards received by agent 202 for the actions taken in environment 301 as illustrated by element 307. Such updated parameters (weights) are then utilized by agent 202 to perform the action of changing the SWAP strategy as illustrated by element 308. Such a change to the SWAP strategy involves how to update the SWAP network, which maps the logical operations to qubits that are physically adjacent.

While the foregoing discusses a “single-round game” in which agent 202 interacts with the environment (e.g., environment 301) only once, making a single decision and receiving a single reward, the principles of the present disclosure may encode the structure of the quantum circuit in an environment by training the machine learning model to reduce the number of SWAP gates in the structure of the quantum circuit while performing quantum circuit routing based on a reinforcement learning approach involving a multiple-round game. In a multiple-round game, the agent interacts with the environment (e.g., environment 301) multiple times within a single episode, making decisions and receiving rewards in each round, allowing for learning based on the cumulative experience across those rounds. For example, after the agent computes the cost function and a reward to evaluate the strength of the noise in the built routed quantum circuit, the agent continues to update the SWAP network, such as by applying one or more SWAP gates, until all SWAP gates are routed or has reached the maximum number of SWAP gates in the SWAP network.

Furthermore, in connection with training the machine learning model to route the quantum circuit to reduce the number of SWAP gates in the structure of the quantum circuit based on a reinforcement learning approach, the structure of the quantum circuit to route and the noise of the built routed quantum circuit are encoded in a cost function as discussed below in connection with FIG. 11.

FIG. 11 is a flowchart of a method 1100 for encoding the structure of the quantum circuit to route and the noise of the built routed quantum circuit in a cost function in accordance with an embodiment of the present disclosure.

Referring to FIG. 11, in conjunction with FIGS. 1-10, in step 1101, encoding engine 203 of classical computer 102 encodes the structure of the quantum circuit to route in an environment in which reinforcement learning agent 202 is exposed.

As discussed above, such a structure of the quantum circuit may be specific to the type of quantum algorithm (e.g., quantum approximate optimization algorithm, Trotter simulations, generation of bell pairs serving as a building block for quantum computing applications, etc.). For example, such a structure may correspond to an unordered set of two-tuples (i, j), with i and j being qubit indices for the quantum approximate optimization algorithm as discussed further below in connection with FIG. 4.

A quantum approximate optimization algorithm, as used herein, is a hybrid quantum-classical algorithm that solves combinational optimization problems. For example, the quantum approximate optimization algorithm transforms a discrete optimization problem into a classical optimization problem over continuous circuit parameters.

In one embodiment, the quantum approximate optimization algorithm uses routing blocks of gates. The mixer (a unitary transformation that may introduce single-qubit rotations in a quantum state) e^{-iβH}^{_{M}} is typically made of local terms thereby enabling the ease of routing. Similarly, the initial state is typically made of local terms. However, the cost operator, e^{-iγH}^{_{C}}, which represents a classical cost function, is built from commuting gates R_{ZZ}(θᵢ). That is, the cost operator encodes the cost function to be optimized.

As a result, in order to route quantum approximate optimization algorithm circuits, only the cost operator e^{-iγH}^{_{C}} is represented in the reinforcement learning environment (e.g., environment 301). In one embodiment, the cost operator is represented as a flat set of edges on which gates act as opposed to the directed acyclic graph of gates.

As shown in FIG. 4, structure 400 of the quantum circuit for the quantum approximate optimization algorithm includes an initial state 401, the cost operator 402, the mixer 403, and the measurement 404. As further illustrated in FIG. 4, instead of representing the cost operator 402 as a directed acyclic graph representation which arbitrarily enforces an order of the R_{ZZ} gates, the following representation {(1,7), (0,1), (6,7), (7,5), (0,2), (3,0), (0,4), (4,7), (5,0), (0,6), (3,7), (0,7)} is utilized by encoding engine 203 to represent the connections between the qubits in the reinforcement learning environment (e.g., environment 301 of FIG. 3) as shown in diagram 405. That is, the machine learning environment (e.g., environment 301 of FIG. 3) encodes such a representation, where the agent's task is to represent the cost operator in the reinforcement learning environment (e.g., environment 301 of FIG. 3) as a flat set of edges on which gates act.

Another example of a structure that corresponds to a specific type of quantum circuit algorithm involves Trotter simulations. A Trotter simulation, as used herein, is a method for simulating quantum systems using the Trotter formula, which breaks down a unitary time evolution into a series of repeated evolutions.

In one embodiment, encoding engine 203 encodes the structure of a quantum circuit corresponding to Trotter simulations in the reinforcement learning environment (e.g., environment 301) as discussed below in connection with FIG. 5.

In Trotter, the time evolution operator, e^{-itH}, needs to be implanted with H=ΣaᵢPᵢ, a sum of Pauli strings. For example, consider P₁=XXXZ (op1), P₂=XXXI (op2), P₃=YYYI (op3), where X (corresponds to a bit flip operation), Y (represents a combination of bit flip and phase flip), Z (changes the phase of a qubit depending on its stat) and I (represents the “do nothing” operation), are the Pauli operators, and op1, op2, and op3 represent the operations.

Trotter creates ladders of CX gates that cancel if the order of the Pᵢ's is chosen wisely. A CX gate, as used herein, refers to a controlled-X gate, which is a quantum logic gate that acts on two qubits. A “ladder” of CX gates refers to a diagonal structure of CX gates that has a depth of n, where n is the number of qubits in the ladder of CX gates.

As shown in FIG. 5, the diagram of quantum circuit 500 includes CX gates 501, Hadamard gates 502, and Rz gates 503. As further shown in FIG. 5, Trotter creates ladders of CX gates (e.g., CX ladder 504) that may cancel if the order of the Pᵢ's is chosen wisely. For example, the Pauli strings of XXXZ, XXXI, YYYI results in the cancellation of CX ladder 504 after the transpilation of quantum circuit 500 resulting in transpiled quantum circuit 505. Transpilation, as used herein, refers to the process of rewriting a given input circuit to match the topology of a specific quantum device and optimizing the circuit instructions for execution on a noisy quantum computer (e.g., quantum computer 101).

In one embodiment, the machine learning environment (e.g., environment 301 of FIG. 3) encodes the Pauli's as a set {P₀, P₁, P₂, . . . }. The agent's task is to find the order of the Pauli's which produces the maximum number of CX ladder cancellations.

In step 1102, encoding engine 203 of classical computer 102 encodes the noise of the built routed quantum circuit in a cost function.

As stated above, noise, as used herein, refers to the unwanted perturbations or errors that occur during the execution of gates (e.g., two-qubit gates) causing the quantum state of the qubits to deviate from the intended ideal state due to interaction with the environment or imperfections in the physical hardware potentially leading to incorrect computation results.

In one embodiment, encoding engine 203 encodes the noise of the built routed quantum circuit in the cost function by measuring the noise in the layer(s) of the gates (e.g., two-qubit gates) of the quantum circuit.

For example, in one embodiment, encoding engine 203 encodes the noise of the built routed quantum circuit in the cost function using a naïve approach to minimize the gate count and gate depth in a circuit, C. As a result, the cost function may be represented as f (C)=aN_{CX}+bN_{layers}, where N_{CX} and N_{layers} are the number of CX gates (two-qubit gates) and the number of layers of the two-qubit gates, respectively. The parameters a and b of the model are then tuned.

In one embodiment, encoding engine 203 encodes the noise of the built routed quantum circuit in the cost function by formulating the cost function based on the γ (measure of the amount of noise in a layer of two-qubit gates) cost of the layers of the two-qubit gates. In one embodiment, the amount of noise in a layer of two-qubit gates is obtained by encoding engine 203 via probabilistic error cancellation, in which the noise of the layers of gates is first learned. In one embodiment, encoding engine 203 uses various software tools for performing probabilistic error cancellation, including, but are not limited to, Mitiq, Qiskit®, etc.

For example, as shown in FIG. 6, the noise cost of the layers of the two-qubit gates are used to form the cost function.

Referring to FIG. 6, the noise cost (Y) for each of the layers 601 of quantum circuit 600 are acquired by a noise model, such as by performing probabilistic error cancellation. As illustrated in FIG. 6, the noise cost (Y) for each of the layers 601 of quantum circuit 600 corresponds to γ₁, γ₁, γ₂, γ₂, γ₃, γ₁, γ₁ resulting in the cost function

$$γ = {γ}_{1}^{4} {γ}_{2}^{2} {γ}_{3} .$$

In one embodiment, encoding engine 203 encodes the noise of the built routed quantum circuit in the cost function by estimating the γ-based cost function.

In such an embodiment, the quantum circuit is transpiled into layers of hardware native gates. The total γ of the quantum circuit is estimated as the product of the γᵢ of layer i.

In one embodiment, measuring the γᵢ of each layer is performed by splitting the training into multiple steps. First, the Y is estimated in a model, e.g., from known quantities such as the two-qubit gate error (e.g., γᵢ=Πⱼ(1+E_{cx,j}) with E_{cx,j}, the error of two-qubit gate j in layer i). Errors, such as crosstalk, will be neglected.

Secondly, once the training is more advanced, the model of γ can be refined by measuring on the target quantum hardware the γᵢ of the most probable layers of gates used by the machine learning in order to capture static and dynamic crosstalk. Static crosstalk, as used herein, refers to the type of crosstalk that is always present in hardware platforms, such as semiconductor and superconductor qubits. It is caused by the constant coupling between qubits. Dynamic crosstalk, as used herein, refers to the type of crosstalk that occurs when leakage from driven gates on other qubits creates an unwanted drive term. For those layers where γᵢ were not measured, such γᵢ can be inferred from the other layers that were measured.

As a result, the γ-based cost function enables the capture of additional sources of noise that would not be captured using an approach, such as the naïve approach. As a result, in one embodiment, the machine learning methods are noise aware. Furthermore, the γ-based cost function enables the overhead of error mitigation (e.g., probabilistic error cancellation, probabilistic error amplification) to be minimized.

Returning to FIG. 9, in step 902, transpilation service 204 of classical computer 102 receives the structure of the quantum circuit to be routed.

As discussed above, in one embodiment, such a structure is received from a user, such as a user of classical computer 102, such as via the user interface of classical computer 102. In one embodiment, such a structure is inferred, such as from the circuit attributes of the quantum circuit. For example, such attributes can be obtained via the QuantumCircuit class of Qiskit®.

In one embodiment, such a structure of the quantum circuit to be routed corresponds to the structure of the quantum circuit that was encoded in the reinforcement learning environment by encoding engine 203.

In step 903, transpilation service 204 of classical computer 102 selects a trained machine learning model out of multiple trained machine learning models based on the received structure of the quantum circuit as illustrated in FIG. 7.

As stated above, referring to FIG. 7, a user 701 communicates to transpilation service 204 regarding performing quantum circuit routing. Transpilation service 204 as used herein, refers to a service that performs transpilation, such as via transpiler 112. In one embodiment, user 701 provides the structure 702 of the quantum circuit to be routed, such as via the user interface of classical computer 102.

In one embodiment, based on the structure of the quantum circuit, which may be inferred, such as by transpilation service 204, transpilation service 204 selects one of the trained machine learning models 703A-703E (labeled as “Model 1,” “Model 2,” “Model 3,” “Model 4,” and “Model 5,” respectively). Machine learning models 703, as used herein, refer to a machine learning model that has been trained to route the quantum circuit by pre-processing the structure of the quantum circuit to route to reduce the number of SWAP gates and minimizing the cost function encoding the structure of the quantum circuit to route and the noise of the built routed quantum circuit.

In one embodiment, each machine learning model 703 is associated with a type of structure of a quantum circuit that the machine learning model 703 was trained to route. For example, each machine learning model 703 may have been trained to route a structure of the quantum circuit for a particular type of quantum algorithm. For instance, machine learning model 703A may have been trained to route a structure of the quantum circuit for the quantum approximate optimization algorithm. Machine learning model 703B may have been trained to route a structure of the quantum circuit for Trotter simulations. Machine learning model 703C may have been trained to route a structure of the quantum circuit for the generation of bell pairs serving as a building block for quantum computing applications and so forth.

In one embodiment, transpilation service 204 selects one of the trained machine learning models 703 based on identifying machine learning model 703 that has been trained to route a structure that most closely matches structure 702, which may be inferred by transpilation service 204, of the quantum circuit to be routed. In one embodiment, the structures upon which machine learning models 703 have been trained are stored in a data structure (e.g., table). Such a data structure may include a listing of structures and the corresponding machine learning models 703 which have been trained to route such associated structures. In one embodiment, transpilation server 204 performs a lookup in such a data structure to identify the structure that most closely matches structure 702, where machine learning model 703 associated with the identified structure is selected to perform quantum circuit routing on the received quantum circuit. In one embodiment, such a data structure resides within the storage device (e.g., storage device 811, 815) of classical computer 102. In one embodiment, such a data structure is populated by an expert.

In one embodiment, transpilation service 204 determines which structure in the data structure, associated with a trained machine learning model 703, most closely matches structure 702 of the quantum circuit to be routed using a pattern-matching algorithm that analyzes the sequences and types of quantum gates within each circuit, considering factors, such as qubit connectivity, gate parameters, and commutation rules, to identify similarities and potential equivalences between them. In one embodiment, such a pattern-matching algorithm utilizes subgraph isomorphism to identify circuit patterns within larger quantum circuits. In one embodiment, such a pattern-matching algorithm utilizes heuristic methods to identify approximate matches based on key features of the structures.

In one embodiment, transpilation service 204 utilizes various pattern matching algorithms to perform pattern-matching for selecting the most appropriate trained machine learning model for performing the quantum circuit routing based on identifying a structure in the data structure, associated with a trained machine learning model 703, that most closely matches structure 702 of the quantum circuit to be routed. Examples of such pattern matching algorithms include, but are not limited to, naïve pattern matching, Knuth-Morris-Pratt (KMP), Boyer-Moore, dynamic programming based approaches, etc.

In step 904, upon selecting the appropriate trained machine learning model (e.g., machine learning model 703D) to perform quantum circuit routing, transpilation service 204 performs quantum circuit routing using the selected trained machine learning model based on pre-processing the structure of the quantum circuit as shown by element 704 to reduce the number of SWAP gates and minimizing the cost function, which reduces the gate count and noise since the structure and noise are encoded in the cost function. The output of the selected machine learning model may then be returned to user 701 or executed on hardware, such as executed on the quantum processing unit (QPU) 705 (e.g., quantum processor 108 of FIG. 1) of quantum computer 101 of FIG. 1.

In this manner, the routing of the quantum circuit is performed in a manner that modifies the quantum circuit to have a low gate count which minimizes the impact of noise thereby enabling error mitigation to be performed or to obtain better results in cases where error mitigation is not possible.

Furthermore, the principles of the present disclosure improve the technology or technical field involving quantum circuit routing.

As discussed above, quantum circuit routing is the process of modifying a quantum circuit so that it meets the connectivity requirements of a target quantum processor. Such a process involves mapping virtual qubits to physical qubits, commonly referred to as a layout. Furthermore, such a process involves inserting SWAP gates (gate that swaps the states of two qubits), which are used to reposition logical qubits so that they are adjacent to each other. This allows the logical gates to only occur between adjacent physical qubits. Additionally, such a process involves minimizing circuit depth (count of the time steps needed to execute all the gates in the quantum circuit). The goal is to minimize the amount of circuit depth added by the SWAP gates. When routing quantum circuits, there are various factors that need to be taken into consideration. For example, not all qubits are connected. Some qubits can be far apart on the chip. Furthermore, SWAP gates are costly and prone to errors. As a result, it is best to avoid using too many SWAP gates. Furthermore, quantum systems are prone to errors and noise, which can affect the accuracy and reliability of quantum circuit routing. For example, quantum hardware is noisy emanating from noise sources, such as energy loss during idle times, loss of coherence in quantum states, static crosstalk (e.g., type of unwanted coupling between qubits that occurs due to always-on qubit-qubit coupling), dynamic crosstalk (e.g., gate induced crosstalk where a gate disturbs neighboring gates or qubits), etc. Algorithms, such as quantum routing algorithms, may be utilized to route quantum circuits. Several quantum routing algorithms include noise in either heuristic algorithms or formal models. Unfortunately, such heuristic algorithms are typically sub-optimal (difficulty in identifying circuits with low gate counts) and perform poorly involving quantum circuits with given symmetries or structures. Furthermore, such formal models do not scale beyond a handful of qubits. In the process of routing quantum circuits, it is desirable to modify the quantum circuit to have a low gate count which minimizes the impact of noise. By minimizing the impact of noise, it makes it easier to perform error mitigation as well as obtain better results in cases where error mitigation is not possible (e.g., sampling-based problems, such as combinational optimization). Unfortunately, current quantum routing algorithms are deficient in routing quantum circuits by modifying the quantum circuit to have a low gate count which minimizes the impact of noise.

Embodiments of the present disclosure improve such technology by encoding a structure of a quantum circuit to route and the noise of a built routed quantum circuit in a cost function. The structure of a quantum circuit, as used herein, refers to the sequence of quantum gates applied to qubits. Noise, as used herein, refers to the unwanted perturbations or errors that occur during the execution of gates (e.g., two-qubit gates) causing the quantum state of the qubits to deviate from the intended ideal state due to interaction with the environment or imperfections in the physical hardware potentially leading to incorrect computation results. A cost function, as used herein, refers to a mathematical function that measures how well the predictions of the machine learning model (e.g., neural network) align with the actual target values. That is, it quantifies the error between the predicted outputs and the true outputs. In one embodiment, the structure of the quantum circuit to route is encoded in the cost function using a reinforcement learning approach, such as a single-round game. That is, the structure of the quantum circuit to route is encoded within a reinforcement learning environment in which the reinforcement learning agent is exposed.

Furthermore, noise is encoded in the cost function, such as by measuring the noise in one or more layers of gates of a built routed quantum circuit. Quantum circuit routing is then performed using a trained machine learning model based on minimizing the cost function, which reduces the gate count and noise since the structure and noise are encoded in the cost function. In this manner, the routing of the quantum circuit is performed in a manner that modifies the quantum circuit to have a low gate count which minimizes the impact of noise thereby enabling error mitigation to be performed or to obtain better results in cases where error mitigation is not possible. Furthermore, in this manner, there is an improvement in the technical field involving quantum circuit routing.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for routing quantum circuits, the method comprising:
encoding a structure of a quantum circuit to route and noise of a built routed quantum circuit in a cost function; and
performing quantum circuit routing using a trained machine learning model based on minimizing said cost function.

2. The method as recited in claim 1 further comprising:
encoding said structure of said quantum circuit to route in an environment using a reinforcement learning agent.

3. The method as recited in claim 2, wherein a cost operator built from a set of commuting gates is represented in said environment as a flat set of edges on which gates act.

4. The method as recited in claim 2, wherein said environment encodes Pauli strings, wherein said reinforcement learning agent identifies an order of said Pauli strings which produces a maximum number of controlled-X (CX) ladder cancellations.

5. The method as recited in claim 1, wherein said noise of said built routed quantum circuit is encoded in said cost function by measuring noise in one or more layers of gates of said built routed quantum circuit.

6. The method as recited in claim 1 further comprising:
selecting one of a plurality of machine learning models to perform said quantum circuit routing based on said structure of said quantum circuit to route.

7. The method as recited in claim 1, wherein said machine learning model is trained using a reinforcement learning approach comprising:
updating, by an agent, a network of SWAP gates applied to said quantum circuit to route;
applying, by said agent, triggered hooks in an environment;
replacing a directed acyclic graph of said quantum circuit to route with a data structure representing said quantum circuit to route;
building a routed quantum circuit to apply SWAP gates and elements from said data structure; and
computing said cost function and a reward to evaluate a strength of noise in said built routed quantum circuit.

8. The method as recited in claim 1, wherein said trained machine learning model pre-processes said structure of said quantum circuit to route to reduce a number of SWAP gates.

9. The method as recited in claim 1, wherein said cost function is based on a number of layers of two-qubit gates, wherein said noise of said built routed quantum circuit is encoded in said cost function based on a noise cost of said layers of said two-qubit gates.

10. A computer program product for routing quantum circuits, the computer program product comprising one or more computer readable storage mediums having program code embodied therewith, the program code comprising programming instructions for:
encoding a structure of a quantum circuit to route in an environment using a reinforcement learning agent;
encoding said structure of said quantum circuit to route and noise of a built routed quantum circuit in a cost function; and
performing quantum circuit routing using a trained machine learning model based on minimizing said cost function.

11. The computer program product as recited in claim 10, wherein the program code further comprises the programming instructions for:
encoding said structure of said quantum circuit in an environment using a reinforcement learning agent.

12. The computer program product as recited in claim 11, wherein a cost operator built from a set of commuting gates is represented in said environment as a flat set of edges on which gates act.

13. The computer program product as recited in claim 11, wherein said environment encodes Pauli strings, wherein said reinforcement learning agent identifies an order of said Pauli strings which produces a maximum number of controlled-X (CX) ladder cancellations.

14. The computer program product as recited in claim 10, wherein said noise of said quantum circuit is encoded in said cost function by measuring noise in one or more layers of gates of said quantum circuit.

15. The computer program product as recited in claim 10, wherein the program code further comprises the programming instructions for:
selecting one of a plurality of machine learning models to perform said quantum circuit routing based on said structure of said quantum circuit to route.

16. The computer program product as recited in claim 10, wherein said machine learning model is trained using a reinforcement learning approach comprising:
updating, by an agent, a network of SWAP gates applied to said quantum circuit to route;
applying, by said agent, triggered hooks in an environment;
replacing a directed acyclic graph of said quantum circuit to route with a data structure representing said quantum circuit to route;
building a routed quantum circuit to apply SWAP gates and elements from said data structure; and
computing said cost function and a reward to evaluate a strength of noise in said built routed quantum circuit.

17. The computer program product as recited in claim 10, wherein said trained machine learning model pre-processes said structure of said quantum circuit to route to reduce a number of SWAP gates.

18. The computer program product as recited in claim 10, wherein said cost function is based on a number of layers of two-qubit gates, wherein said noise of said built routed quantum circuit is encoded in said cost function based on a noise cost of said layers of said two-qubit gates.

19. A system, comprising:
a memory for storing a computer program for routing quantum circuits; and
a processor connected to said memory, wherein said processor is configured to execute program instructions of the computer program comprising:
encoding a structure of a quantum circuit to route in an environment using a reinforcement learning agent;
encoding said structure of said quantum circuit to route and noise of a built routed quantum circuit in a cost function; and
performing quantum circuit routing using a trained machine learning model based on minimizing said cost function.

20. The system as recited in claim 19, wherein the program instructions of the computer program further comprise:
encoding said structure of said quantum circuit in an environment using a reinforcement learning agent.
